(19) United States
(12) Patent Application Publication
(10) Pub. No.: US 2021/0281924 A1
(43) Pub. Date: Sep. 9, 2021

(54) SYSTEM AND METHOD FOR EFFICIENT AD MANAGEMENT STORAGE FOR RECORDED ASSETS

(71) Applicant: ARRIS Enterprises LLC, Suwanee, GA (US)

(72) Inventors: Sadeesh Kumar Karuppiah, Battrahalli (IN); Christopher S. DelSordo, Souderton, PA (US)

(73) Assignee: ARRIS Enterprises LLC, Suwanee, GA (US)

(21) Appl. No.: 17/186,766

(22) Filed: Feb. 26, 2021

Related U.S. Application Data
(60) Provisional application No. 62/984,860, filed on Mar. 4, 2020.

(51) Int. Cl. H04N 21/81; H04N 21/274; H04N 21/845

(52) U.S. Cl. CPC H04N 21/812; H04N 21/845; H04N 21/8126; H04N 21/274

(57) ABSTRACT

System and method for recording network programs including targeted advertisements, including receiving a network program including program content and targeted advertisements; identifying the targeted advertisements included within the network program; removing the targeted advertisements from the network program; associating a unique Ad ID with each different targeted advertisement; storing the targeted advertisements separate from the program content at a first memory location, where each different targeted advertisement is stored only once; inserting into the network program index points identifying positions within the network program at which the targeted advertisements occur; associating a unique Ad ID with each different targeted advertisement; creating an index file associating each index point with the Ad ID of the targeted advertisement occurring at the position identified by each index point; and storing the received network program including the program content and the index points in place of the targeted advertisements at a second memory location.

### FIELD OF THE DISCLOSURE

The present disclosure relates generally to recording network programs that include targeted commercial advertisements.

### BACKGROUND OF THE DISCLOSURE

It is common in today's society to record television programs for viewing at a later date. Recording television programming may be due to a viewer's busy schedule, multiple programs occurring at the same time, or a viewer may simply want to watch a television program at a later date/time that is more convenient. Recording also offers the viewer the option of watching the television program multiple times, in which they may notice or identify instance or occurrences in the program that they missed the first time(s).

Such recorded programming can be stored locally (e.g., in the set top box) or in the cloud. Either way, saving or storing the recorded content in an optimal manner is always important. When a network program is recorded that includes targeted advertisements in the form of commercials, the targeted commercial advertisements get recorded and stored along with the network program. If the targeted advertisement appears multiple times in the same network program, it gets stored multiple times as the network program is stored.

If multiple network programs are recorded, it is possible that the same targeted commercial advertisement appears in the different network programming. This same targeted commercial advertisement will again get recorded (possibly multiple time) with each network program in which is appears. A targeted commercial advertisement may also appear in other channels at the same time or other times. Thus, when network programs are recorded, the same targeted commercial advertisement may end up getting recorded multiple as part of every recorded network program or asset. As can be appreciated, as the recorded network programming library grows, storage space can be drastically impacted, especially if a user does not purge their recorded library periodically. Users may be forced to delete recorded programming that they would otherwise wish to retain for future viewing to make space for current recordings.

The present disclosure is directed at overcoming one or more of the above-identified problems.

### SUMMARY OF THE DISCLOSURE

The present disclosure will save valuable storage space on a set-top box or other memory device which can be used for valid new recorded programs and other assets. When recording a network program or digital audio-video stream, the present disclosure does not store the ad as part of the digital stream. Instead, a separate index file is maintained to keep track of ad location and Ad ID. The generated index file is used to stitch or insert the ad during playback of the recorded program or asset.

In accordance with the present disclosure, ads are recorded only once and are recorded separate from the recorded program. The same recorded content is used when playing back multiple times in scenarios where the same targeted advertisement is used within the same recorded program or across multiple programs, on the same or other channel. As the recoded program in played back, a targeting advertisement location pointer (i.e., index pointer) is read from an index file and used to play back the targeted ad at the precise time the ad should be displayed in the program

The index file is generated for every recorded program or asset. The index file includes additional targeted ad location pointers stored at the specific time in the program where the ad should be displayed. The location pointers are matched with the Ad ID of the ad appearing at that particular time. Formation of the index file helps track the ad location using a timestamp and Ad ID that are generated, while storing each ad only once in a memory separate from the recorded program.

In one embodiment, a method for recording a network program including targeted commercial advertisements is disclosed. The method includes receiving a first digital audio-video stream; identifying a first targeted commercial advertisement included within the first digital audio-video stream; removing the first targeted commercial advertisement from the first digital audio-video stream; storing the first targeted commercial advertisement at a first memory location; associating a first Ad ID with the first targeted commercial advertisement; inserting into the digital audio-video stream a first index point identifying a position within the first audio-video stream at which the first targeted commercial advertisement occurs; associating the first index point with the first Ad ID; storing the first index point and the first Ad ID in an index file; and storing the received first audio-video stream including the first index point in place of the first targeted commercial advertisement at a second memory location

In one embodiment, a method for recording a network program including targeted commercial advertisements is disclosed. The method includes receiving a first digital audio-video stream; identifying a first targeted commercial advertisement included within the first digital audio-video stream; removing the first targeted commercial advertisement from the first digital audio-video stream; storing the first targeted commercial advertisement at a first memory location; associating a first Ad ID with the first targeted commercial advertisement; inserting into the digital audio-video stream a first index point identifying a position within the first audio-video stream at which the first targeted commercial advertisement occurs; associating the first index point with the first Ad ID; storing the first index point and the first Ad ID in an index file; and storing the received first audio-video stream including the first index point in place of the first targeted commercial advertisement at a second memory location.

In one form of the disclosed method, the method further includes initiating a playback of the recorded first digital audio-video stream from the second memory location; identifying the first index point during the playback; reading the first Ad ID from the index file based on the first index point; retrieving the first targeted commercial advertisement from the first memory location based on the first Ad ID; and playing back the first targeted commercial advertisement at the position within the first digital audio-video stream identified by the first index point.

In one form of the disclosed method, the method further includes receiving a second digital audio-video stream; identifying the first targeted commercial advertisement included within the second digital audio-video stream; removing the first targeted commercial advertisement from the second digital audio-video stream; determining that the first targeted advertisement has already been stored at the first memory location; inserting into the second digital audio-video stream a second index point identifying a position within the second audio-video stream at which the first targeted commercial advertisement occurs; associating the second index point with the first Ad ID previously associated with the stored first targeted commercial advertisement; storing the second index point and the first Ad ID in the index file; and storing the received second audio-video stream including the second index point in place of the first targeted commercial advertisement at the second memory location.

In one form of the disclosed method, the method further includes initiating a playback of the recorded second digital audio-video stream from the second memory location; identifying the second index point during the playback; reading the first Ad ID from the index file based on the second index point; retrieving the first targeted commercial advertisement from the first memory location based on the first Ad ID; and playing back the first targeted commercial advertisement at the position within the second digital audio-video stream identified by the second index point.

In another embodiment, a method for recording a network program including targeted commercial advertisements is disclosed. The method includes receiving a digital audio-video stream including program content and targeted commercial advertisements; identifying the targeted commercial advertisements included within the digital audio-video stream; removing the targeted commercial advertisements from the digital audio-video stream; associating a unique Ad ID with each different commercial advertisement; storing the targeted commercial advertisements separate from the program content at a first memory location, where each different targeted advertisement is stored only once; inserting into the digital audio-video stream index points identifying positions within the digital audio-video stream at which the targeted commercial advertisements occur; associating a unique Ad ID with each different commercial advertisement; creating an index file associating each index point with the Ad ID of the targeted commercial advertisement occurring at the position identified by each index point; and storing the received digital audio-video stream including the program content and the index points in place of the targeted commercial advertisements at a second memory location.

In one form of the disclosed method, the method further includes initiating a playback of the digital audio-video stream from the second memory location; identifying the index points during the playback; reading Ad IDs from the index file based on the index points; retrieving the stored targeted commercial advertisements from the first memory location based on the read Ad IDs; and playing back the targeted commercial advertisement at positions within the digital audio-video stream identified by the index points.

In one form of the disclosed method, the method further includes identifying a first targeted commercial advertisement included in the digital audio-video stream; determining whether the first targeted commercial advertisement is stored at the first memory location; if it is determined that the first targeted commercial advertisement has not been stored: storing the first targeted commercial advertisement at the first memory location; associating a first Ad ID with the first targeted commercial advertisement; inserting into the digital audio-video stream a first index point identifying a position within the digital audio-video stream at which the first targeted commercial advertisement occurs; associating the first index point with the first Ad ID; storing the first index point and the first Ad ID in an index file; and storing the received first audio-video stream including the first index point in place of the first targeted commercial advertisement at a second memory location; if it is determined that the first targeted commercial advertisement has previously been stored: inserting into the digital audio-video stream a first index point identifying a position within the digital audio-video stream at which the first targeted commercial advertisement occurs; associating the first index point a first Ad ID previously associated with the first targeted advertisement; storing the first index point and the first Ad ID in an index file; and storing the received first audio-video stream including the first index point in place of the first targeted commercial advertisement at a second memory location.

In one form of the disclosed method, the method further includes initiating a playback of the recorded digital audio-video stream from the second memory location; identifying the first index point during the playback; reading the first Ad ID from the index file based on the first index point; retrieving the first targeted commercial advertisement from the first memory location based on the first Ad ID; and playing back the first targeted commercial advertisement at the position within the digital audio-video stream identified by the first index point.

In another embodiment, a system for recording a network program including targeted commercial advertisements is disclosed. The system includes a computing device receiving a first digital audio-video stream; and a processing device configured to: identify a first targeted commercial advertisement included within the first digital audio-video stream; remove the first targeted commercial advertisement from the first digital audio-video stream; store the first targeted commercial advertisement at a first memory location; associate a first Ad ID with the first targeted commercial advertisement; insert into the digital audio-video stream a first index point identifying a position within the first audio-video stream at which the first targeted commercial advertisement occurs; associate the first index point with the first Ad ID; store the first index point and the first Ad ID in an index file; and store the received first audio-video stream including the first index point in place of the first targeted commercial advertisement at a second memory location.

In one form of the disclosed system, the processor is further configured to: initiate a playback of the recorded first digital audio-video stream from the second memory location; identify the first index point during the playback; read the first Ad ID from the index file based on the first index point; retrieve the first targeted commercial advertisement from the first memory location based on the first Ad ID; and play back the first targeted commercial advertisement at the position within the first digital audio-video stream identified by the first index point.

In one form of the disclosed system, a second digital audio-video stream is received at the computing device, and the processor is further configured to: identify the first targeted commercial advertisement included within the second digital audio-video stream; remove the first targeted commercial advertisement from the second digital audio-video stream; determine that the first targeted advertisement has already been stored at the first memory location; insert into the second digital audio-video stream a second index point identifying a position within the second audio-video stream at which the first targeted commercial advertisement occurs; associate the second index point with the first Ad ID previously associated with the stored first targeted commercial advertisement; store the second index point and the first Ad ID in the index file; and store the received second audio-video stream including the second index point in place of the first targeted commercial advertisement at the second memory location.

In one form of the disclosed system, the processor is further configured to: initiate a playback of the recorded second digital audio-video stream from the second memory location; identify the second index point during the playback; read the first Ad ID from the index file based on the second index point; retrieve the first targeted commercial advertisement from the first memory location based on the first Ad ID; and play back the first targeted commercial advertisement at the position within the second digital audio-video stream identified by the second index point.

In another embodiment, a system for recording a network program including targeted commercial advertisements is disclosed. The system includes a computing device receiving a digital audio-video stream including program content and targeted commercial advertisements; and a processor configured to: identify the targeted commercial advertisements included within the digital audio-video stream; remove the targeted commercial advertisements from the digital audio-video stream; associate a unique Ad ID with each different commercial advertisement; storing the targeted commercial advertisements separate from the program content at a first memory location, where each different targeted advertisement is stored only once; insert into the digital audio-video stream index points identifying positions within the digital audio-video stream at which the targeted commercial advertisements occur; associate a unique Ad ID with each different commercial advertisement; creating an index file associating each index point with the Ad ID of the targeted commercial advertisement occurring at the position identified by each index point; and store the received digital audio-video stream including the program content and the index points in place of the targeted commercial advertisements at a second memory location.

In one form of the disclosed system, the processor is further configured to: initiate a playback of the digital audio-video stream from the second memory location; identify the index points during the playback; read Ad IDs from the index file based on the index points; retrieve the stored targeted commercial advertisements from the first memory location based on the read Ad IDs; and play back the targeted commercial advertisement at positions within the digital audio-video stream identified by the index points.

In one form of the disclosed system, the processor is further configured to: identify a first targeted commercial advertisement included in the digital audio-video stream; determine whether the first targeted commercial advertisement is stored at the first memory location; if it is determined that the first targeted commercial advertisement has not been stored: store the first targeted commercial advertisement at the first memory location; associate a first Ad ID with the first targeted commercial advertisement; insert into the digital audio-video stream a first index point identifying a position within the digital audio-video stream at which the first targeted commercial advertisement occurs; associate the first index point with the first Ad ID; store the first index point and the first Ad ID in an index file; and store the received first audio-video stream including the first index point in place of the first targeted commercial advertisement at a second memory location; if it is determined that the first targeted commercial advertisement has previously been stored: insert into the digital audio-video stream a first index point identifying a position within the digital audio-video stream at which the first targeted commercial advertisement occurs; associate the first index point a first Ad ID previously associated with the first targeted advertisement; store the first index point and the first Ad ID in an index file; and store the received first audio-video stream including the first index point in place of the first targeted commercial advertisement at a second memory location.

In one form of the disclosed system, the processor is further configured to: initiate a playback of the recorded digital audio-video stream from the second memory location; identify the first index point during the playback; read the first Ad ID from the index file based on the first index point; retrieve the first targeted commercial advertisement from the first memory location based on the first Ad ID; and play back the first targeted commercial advertisement at the position within the digital audio-video stream identified by the first index point.

Additional features, aspects, objects, advantages, and possible applications of the present disclosure will become apparent from a study of the exemplary embodiments and examples described below, in combination with the Figures, and the appended claims.

### BRIEF DESCRIPTION OF THE DRAWINGS

FIG. 1 is a schematic diagram that illustrates digital video streams having targeted commercial advertisements included within the digital video streams;

FIG. 2 is a schematic diagram that illustrates digital audio-video streams having targeted commercial advertisements included within the digital audio-video streams;

FIG. 3 is a schematic diagram that illustrates placing index points in the digital audio-video streams in place of the targeted commercial advertisements, storing the targeted commercial advertisements separate from the digital audio-video stream, and an index file associating the index points with Ad IDs of the targeted commercial advertisement occurring at the position of the index point; and

FIG. 4 is an illustration of exemplary hardware architecture for an embodiment of a communication device.

### DETAILED DESCRIPTION OF THE DISCLOSURE

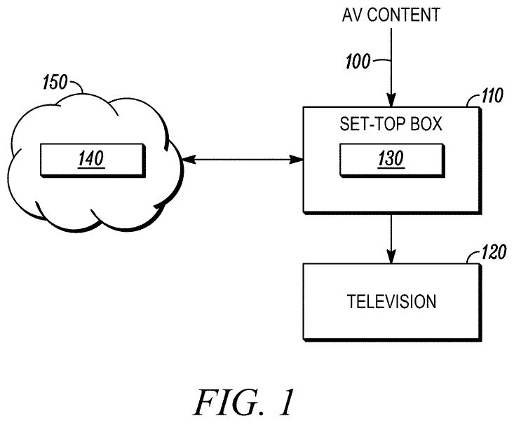

Referring to FIG. 1, a block diagram is shown illustrating an exemplary environment for receiving and recording network programs including program content and targeted commercial advertisements. A digital audio-video signal 100 is transmitted by a programming network (not shown) and received by a set-top box 110. The set-top box 110 is a computing device that connects to a television 120. The set-top box 110 is a digital video recorder (DVR) that a subscriber (not shown) operates to receive and view the digital audio-video signal 100 on the television 120. Should a subscriber wish to record a network program (i.e, the digital audio-video 100) and view it at a later time, the set-top box 110 stores the digital audio-video signal 100. The digital audio-video signal can be stored either in a memory 130 within the set-top box 130, or at a remote memory 140 located, for example, in the cloud 150.

A network program typically includes program content and commercial advertisement periodically inserted in the program content. Such commercial advertisements often include targeted commercial advertisements. Targeted commercial advertisements are targeted to specific consumers watching television. Targeting can be done according to age, gender, location, personal interests in films, etc.

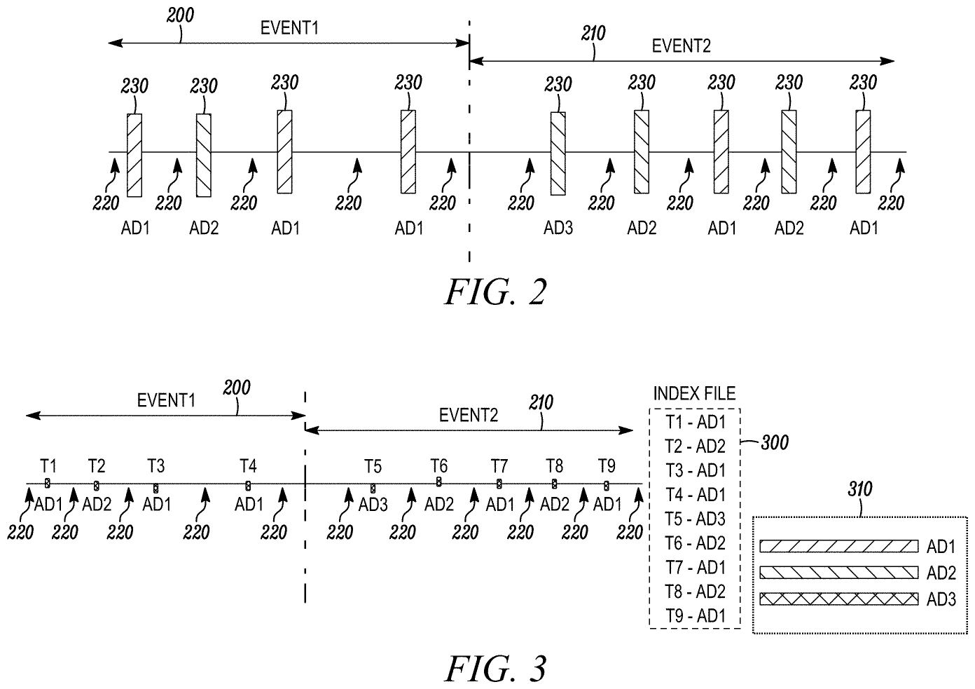

FIG. 2 illustrates two network programs 200 (Event1) and 210 (Event2) that occur consecutively on a given channel. The network programs 200 and 210 each include program content at 220 and targeted commercial advertisements 230 periodically inserted in the program content 220. Some targeted commercial advertisements 230 may appear more than once in the same network program and may also appear in other network programs on the same or other channels.

In the present disclosure, the targeted commercial advertisements 230 are identified by Ad IDs. In network program 200 there are two different targeted commercial advertisements 230, namely, Ad1 and Ad2. In network program 210, there are three different targeted commercial advertisements 230, namely, Ad1, Ad2 and Ad3. As shown in FIG. 2, Ad1 appears three times in network program 200 and twice in network program 210. Ad2 appears once in network program 200 and twice in network program 210. Ad3 appears once in only network program 210.

In current recording schemes, should a subscriber desire to record network program 200, the entire program would be recorded as one continuous event with the targeted commercial advertisement 230 recorded as many times as it appears in the program. This means that Ad1 would be recorded three times and Ad2 would be recorded once. Similarly, for network program 210, Ad1 would be recorded twice, Ad2 would be recorded twice, and Ad3 would be recorded once. Thus, even though only three different targeted network commercial advertisements are included in network programs 200 and 210, they are recorded a combined total of eight times.

FIG. 3 illustrates replacing the advertisements included in the network programs with index points identifying positions in the network programs where the advertisements occur. As shown in FIG. 3, four index points T1, T2, T3 and T4 are inserted into the network program 200 at the positions were the various advertisements occur. The index points and Ad IDs are stored in an index file 300 matching the index points with the advertisements. For example, in FIG. 3, index point T1 is matched with Ad1, index point T2 is matched with Ad2, index point T3 is matched with Ad1 and index point T4 is matched with Ad1.

The network program 200 is recorded, either locally or remotely, with the advertisements removed and index points inserted in their place. Thus, the recorded program 200 consists of program content 220 and index points T1, T2, T3, T4 in place of the advertisements. The advertisements Ad1 and Ad2 are recorded in a memory location 310 separated from the recorded program 200. This memory location may be local at the set-top box 110 or remotely in the cloud 150 or elsewhere. Importantly, the advertisements are recorded only once, regardless of the number of times they appear in the network program 200.

As the network program 200 is being recorded, the targeted advertisements 230 are identified. Identification may be done by a variety of methods, including, but not limited to comparing initial frames of the advertisements, identifying unique IP streams or other identifiers including within the targeted advertisements, etc. Once an advertisement is identified, it is determined if it has already been recorded. If it has not been recorded, the advertisement is recorded in the memory location 310, an index point is inserted into the program content, and the index point and Ad ID for that particular advertisement are stored in the index file. If the advertisement has previously been recorded, an index point is inserted into the program content and the index point and Ad ID for that particular advertisement are stored in the index file. It is important to note that since the advertisement has already been stored, it is not stored again. The index point is simply matched with the appropriated Ad ID so that the advertisement may be retrieved during playback.

During playback, when the index point is encountered, it is matched with the appropriate AD ID in the index file 300 and is used to retrieve the advertisement from the memory location 310 and play back the advertisement at the appropriate time. There is no change in the presentation to the use.

Referring to FIG. 3, when network program 200 is recorded, Ad1 is first identified (going from left to right). It is determined that Ad1 is not yet stored in the ad memory 310. Ad1 is stored in the ad memory 310 and an index point T1 is inserted in the network program 200 in place of Ad1. The index point T1 is matched with Ad ID Ad1 and the two are stored in the index file 300. Next, Ad2 is identified. It is determined that Ad2 is not yet stored in the ad memory 310. Ad2 is stored in the ad memory 310 and an index point T2 is inserted in the network program 200 in place of Ad2. The index point T2 is matched with Ad ID Ad2 and the two are stored in the index file 300. Next, Ad1 (second instance) is encountered and identified. It is determined that Ad1 has previously been stored in the ad memory 310. Thus, Ad1 is not stored again. An index point T3 is inserted in the network program 200 in place of Ad1 (second instance). The index point T3 is matched with Ad ID Ad1 and the two are stored in the index file 300. Finally, Ad1 (third instance) is encountered and identified. It is determined that Ad1 has previously been stored in the ad memory 310. Thus, Ad1 is not stored again. An index point T4 is inserted in the network program 200 in place of Ad1 (third instance). The index point T4 is matched with Ad ID Ad1 and the two are stored in the index file 300.

The same process is utilized when network programs 210 is recorded. Ad3 is first identified (going from left to right). It is determined that Ad3 is not yet stored in the ad memory 310. Ad3 is stored in the ad memory 310 and an index point T5 is inserted in the network program 200 in place of Ad3. The index point T5 is matched with Ad ID Ad3 and the two are stored in the index file 300. Since Ad1 and Ad2 have been previously recorded, when they are encountered during the recording of network program 210, the system/method will identify them and determine that they have been previously recorded and will not record them again. Index points will be inserted into the network program and the index points will be match with the appropriate Ad ID and the two stored together in the index file 300.

As shown in the example of FIG. 3, when network programs 200 and 210 are recorded, there are nine advertisements consisting of three different advertisements are included in the program. In prior art schemes, these nine advertisements would have been recorded nine times with advertisements recorded multiple times. With the current system/method, only three advertisements are recorded, once each, and index points are used to match the advertisements to their AD IDs in an index file. This will save valuable storage space that may be used for valid new programs and other assets.

As previously noted, during playback, when the index point is encountered, it is matched with the appropriate AD ID in the index file 300 and is used to retrieve the advertisement from the memory location 310 and play back the advertisement at the appropriate time. For example, when index point T1 is encountered, it is used (via the index file 300) to retrieve advertisement Ad1 from the ad memory 310 and play it back at the appropriate time. When index point T2 is encountered, it is used (via the index file 300) to retrieve advertisement Ad2 from the ad memory 310 and play it back at the appropriate time. A similar process occurs as each index point T1-T9 is encountered during play back of network programs 200 and 210.

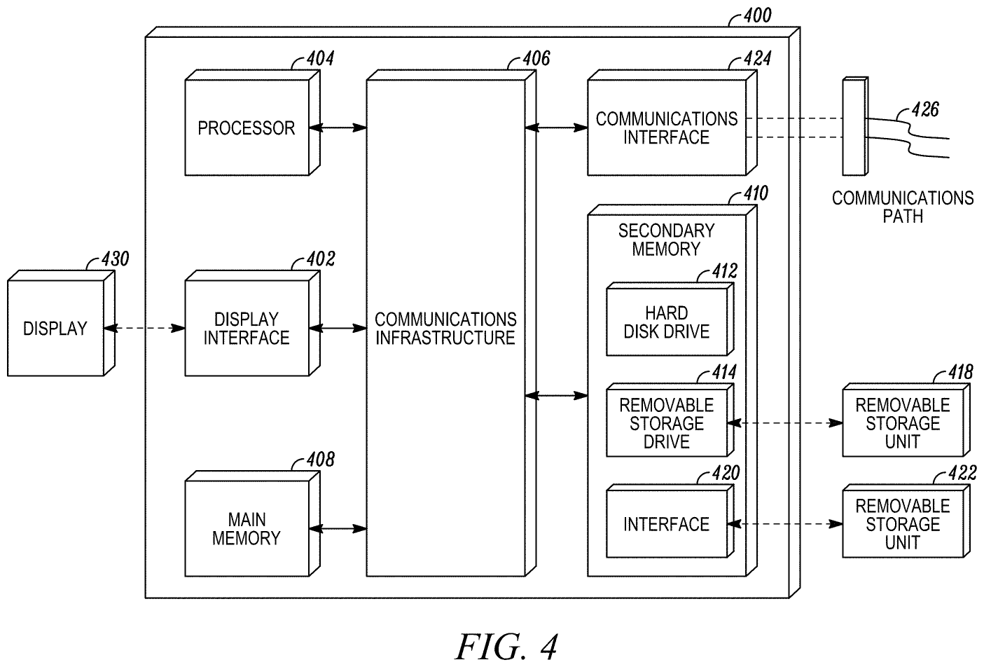

FIG. 4 illustrates a representative computer system 400 in which embodiments of the present disclosure, or portions thereof, may be implemented as computer-readable code. For example, the set-top box 110, and other devices and services, either locally or remotely may be implemented in whole or in part by a computer system 400 using hardware, software, firmware, non-transitory computer readable media having instructions stored thereon, or a combination thereof and may be implemented in one or more computer systems or other processing systems. Hardware, software executed in a processor, or any combination thereof may embody modules and components used to implement the methods and steps of the present disclosure.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 418, a removable storage unit 422, and a hard disk installed in hard disk drive 412.

Various embodiments of the present disclosure are described in terms of this representative computer system 400. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device specifically configured to perform the functions discussed herein. The processor device 404 may be connected to a communications infrastructure 406, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 400 may also include a main memory 408 (e.g., random access memory, read-only memory, etc.), and may also include a secondary memory 410. The secondary memory 410 may include the hard disk drive 412 and a removable storage drive 414, such as a floppy disk drive, a magnetic tape drive, an optical disk drive, a flash memory, etc.

The removable storage drive 414 may read from and/or write to the removable storage unit 418 in a well-known manner. The removable storage unit 418 may include a removable storage media that may be read by and written to by the removable storage drive 414. For example, if the removable storage drive 414 is a floppy disk drive or universal serial bus port, the removable storage unit 418 may be a floppy disk or portable flash drive, respectively. In one embodiment, the removable storage unit 418 may be non-transitory computer readable recording media.

In some embodiments, the secondary memory 410 may include alternative means for allowing computer programs or other instructions to be loaded into the computer system 400, for example, the removable storage unit 422 and an interface 420. Examples of such means may include a program cartridge and cartridge interface (e.g., as found in video game systems), a removable memory chip (e.g., EEPROM, PROM, etc.) and associated socket, and other removable storage units 422 and interfaces 420 as will be apparent to persons having skill in the relevant art.

Data stored in the computer system 400 (e.g., in the main memory 508 and/or the secondary memory 410) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 400 may also include a communications interface 424. The communications interface 424 may be configured to allow software and data to be transferred between the computer system 400 and external devices. Exemplary communications interfaces 424 may include a modem, a network interface (e.g., an Ethernet card), a communications port, a PCMCIA slot and card, etc. Software and data transferred via the communications interface 424 may be in the form of signals, which may be electronic, electromagnetic, optical, or other signals as will be apparent to persons having skill in the relevant art. The signals may travel via a communications path 426, which may be configured to carry the signals and may be implemented using wire, cable, fiber optics, a phone line, a cellular phone link, a radio frequency link, etc.

The computer system 400 may further include a display interface 402. The display interface 402 may be configured to allow data to be transferred between the computer system 400 and external display 430. Exemplary display interfaces 402 may include high-definition multimedia interface (HDMI), digital visual interface (DVI), video graphics array (VGA), etc. The display 430 may be any suitable type of display for displaying data transmitted via the display interface 402 of the computer system 400, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 408 and secondary memory 510, which may be memory semiconductors (e.g., DRAMs, etc.). These computer program products may be means for providing software to the computer system 400. Computer programs (e.g., computer control logic) may be stored in the main memory 408 and/or the secondary memory 410. Computer programs may also be received via the communications interface 424. Such computer programs, when executed, may enable computer system 400 to implement the present methods as discussed herein. In particular, the computer programs, when executed, may enable processor device 404 to implement the methods as discussed herein. Accordingly, such computer programs may represent controllers of the computer system 400. Where the present disclosure is implemented using software executed on hardware, the software may be stored in a computer program product and loaded into the computer system 400 using the removable storage drive 414, interface 420, and hard disk drive 412, or communications interface 424.

The processor device 404 may comprise one or more modules or engines configured to perform the functions of the computer system 400. Each of the modules or engines may be implemented using hardware and, in some instances, may also utilize software executed on hardware, such as corresponding to program code and/or programs stored in the main memory 408 or secondary memory 410. In such instances, program code may be compiled by the processor device 404 (e.g., by a compiling module or engine) prior to execution by the hardware of the computer system 400. For example, the program code may be source code written in a programming language that is translated into a lower level language, such as assembly language or machine code, for execution by the processor device 404 and/or any additional hardware components of the computer system 400. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 400 being a specially configured computer system 400 uniquely programmed to perform the functions discussed above.

Techniques consistent with the present disclosure provide, among other features, systems and methods for recording network programs that include targeted commercial advertisements the displaying of a graphical symbol as an SSID representative of a Wi-Fi network on a mobile user device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

I/We claim:

1. A method for recording a network program including targeted commercial advertisements, comprising:
receiving a first digital audio-video stream;
identifying a first targeted commercial advertisement included within the first digital audio-video stream;
removing the first targeted commercial advertisement from the first digital audio-video stream;
inserting into the digital audio-video stream a first index point identifying a position within the first audio-video stream at which the first targeted commercial advertisement occurs;
determining whether the first targeted commercial advertisement is stored at a first memory location;
if it is determined that the first targeted commercial advertisement is not stored at the first memory location:
storing the first targeted commercial advertisement at the first memory location; and
associating a first Ad ID with the first targeted commercial advertisement;
if it is determined that the first targeted commercial advertisement has been previously stored at the first memory location:
not re-storing the first targeted commercial advertisement at the first memory location; and
identifying a second Ad ID previously associated with the first targeted commercial advertisement stored at the first memory location;
associating the first index point with the first/second Ad ID;
storing the first index point and the first/second Ad ID in an index file; and
storing the received first audio-video stream including the first index point in place of the first targeted commercial advertisement at a second memory location.

2. The method of claim 1, further comprising:
initiating a playback of the recorded first digital audio-video stream from the second memory location;
identifying the first index point during the playback;
reading the first/second Ad ID from the index file based on the first index point;
retrieving the first targeted commercial advertisement from the first memory location based on the first/second Ad ID; and
playing back the first targeted commercial advertisement at the position within the first digital audio-video stream identified by the first index point.

3. The method of claim 1, further comprising:
receiving a second digital audio-video stream;
identifying the first targeted commercial advertisement included within the second digital audio-video stream;
removing the first targeted commercial advertisement from the second digital audio-video stream;
determining that the first targeted commercial advertisement has already been stored at the first memory location;
inserting into the second digital audio-video stream a second index point identifying a position within the second audio-video stream at which the first targeted commercial advertisement occurs;
associating the second index point with the first/second Ad ID previously associated with the stored first targeted commercial advertisement;
storing the second index point and the first/second Ad ID in the index file; and
storing the received second audio-video stream including the second index point in place of the first targeted commercial advertisement at the second memory location.

4. The method of claim 3, further comprising:
initiating a playback of the recorded second digital audio-video stream from the second memory location;
identifying the second index point during the playback;
reading the first Ad ID from the index file based on the second index point;
retrieving the first targeted commercial advertisement from the first memory location based on the first Ad ID; and
playing back the first targeted commercial advertisement at the position within the second digital audio-video stream identified by the second index point.

5. A method of recording a network program including targeted commercial advertisements, comprising:
receiving a digital audio-video stream including program content and targeted commercial advertisements;
identifying the targeted commercial advertisements included within the digital audio-video stream;
removing the targeted commercial advertisements from the digital audio-video stream;
associating a unique Ad ID with each different targeted commercial advertisement, wherein Ad IDs are used to determine uniqueness of targeted commercial advertisements;
storing the targeted commercial advertisements separate from the program content at a first memory location, where each different targeted commercial advertisement is stored only once;
inserting into the digital audio-video stream index points identifying positions within the digital audio-video stream at which the targeted commercial advertisements occur;
creating an index file associating each index point with the Ad ID of the targeted commercial advertisement occurring at the position identified by each index point; and
storing the received digital audio-video stream including the program content and the index points in place of the targeted commercial advertisements at a second memory location.

6. The method of claim 5, further comprising:
initiating a playback of the digital audio-video stream from the second memory location;
identifying the index points during the playback;
reading Ad IDs from the index file based on the index points;
retrieving the stored targeted commercial advertisements from the first memory location based on the read Ad IDs; and
playing back the targeted commercial advertisement at positions within the digital audio-video stream identified by the index points.

7. The method of claim 5, further comprising:
identifying a first targeted commercial advertisement included in the digital audio-video stream and a first Ad ID associated with the first targeted commercial advertisement;
determining, using the first Ad ID, whether the first targeted commercial advertisement is stored at the first memory location;
if it is determined that the first targeted commercial advertisement has not been stored:
storing the first targeted commercial advertisement at the first memory location;
inserting into the digital audio-video stream a first index point identifying a position within the digital audio-video stream at which the first targeted commercial advertisement occurs;
associating the first index point with the first Ad ID;
storing the first index point and the first Ad ID in an index file; and
storing the received first audio-video stream including the first index point in place of the first targeted commercial advertisement at a second memory location;
if it is determined that the first targeted commercial advertisement has previously been stored:
inserting into the digital audio-video stream a first index point identifying a position within the digital audio-video stream at which the first targeted commercial advertisement occurs;
associating the first index point with the first Ad ID previously associated with the first targeted advertisement;
storing the first index point and the first Ad ID in an index file; and
storing the received first audio-video stream including the first index point in place of the first targeted commercial advertisement at a second memory location.

8. The method of claim 7, further comprising:
initiating a playback of the recorded digital audio-video stream from the second memory location;
identifying the first index point during the playback;
reading the first Ad ID from the index file based on the first index point;
retrieving the first targeted commercial advertisement from the first memory location based on the first Ad ID; and
playing back the first targeted commercial advertisement at the position within the digital audio-video stream identified by the first index point.

9. A system for recording a network program including targeted commercial advertisements, comprising;
a computing device receiving a first digital audio-video stream;
a processing device configured to:
identify a first targeted commercial advertisement included within the first digital audio-video stream;
remove the first targeted commercial advertisement from the first digital audio-video stream;
store the first targeted commercial advertisement at a first memory location;
associate a first Ad ID with the first targeted commercial advertisement;
insert into the digital audio-video stream a first index point identifying a position within the first audio-video stream at which the first targeted commercial advertisement occurs;
associate the first index point with the first Ad ID;
store the first index point and the first Ad ID in an index file; and
store the received first audio-video stream including the first index point in place of the first targeted commercial advertisement at a second memory location.

10. The system of claim 9, wherein the processor is further configured to:
initiate a playback of the recorded first digital audio-video stream from the second memory location;
identify the first index point during the playback;
read the first Ad ID from the index file based on the first index point;
retrieve the first targeted commercial advertisement from the first memory location based on the first Ad ID; and
play back the first targeted commercial advertisement at the position within the first digital audio-video stream identified by the first index point.

11. The system of claim 9, wherein a second digital audio-video stream is received at the computing device, and wherein the processor is further configured to:
identify the first targeted commercial advertisement included within the second digital audio-video stream;
remove the first targeted commercial advertisement from the second digital audio-video stream;
determine that the first targeted advertisement has already been stored at the first memory location;
insert into the second digital audio-video stream a second index point identifying a position within the second audio-video stream at which the first targeted commercial advertisement occurs;
associate the second index point with the first Ad ID previously associated with the stored first targeted commercial advertisement;
store the second index point and the first Ad ID in the index file; and
store the received second audio-video stream including the second index point in place of the first targeted commercial advertisement at the second memory location.

12. The system of claim 11, wherein the processor is further configured to:
initiate a playback of the recorded second digital audio-video stream from the second memory location;
identify the second index point during the playback;
read the first Ad ID from the index file based on the second index point;
retrieve the first targeted commercial advertisement from the first memory location based on the first Ad ID; and
play back the first targeted commercial advertisement at the position within the second digital audio-video stream identified by the second index point.

13. A system for recording a network program including targeted commercial advertisements, comprising:
a computing device receiving a digital audio-video stream including program content and targeted commercial advertisements;
a processor configured to:
identify the targeted commercial advertisements included within the digital audio-video stream;
remove the targeted commercial advertisements from the digital audio-video stream;
associate a unique Ad ID with each different commercial advertisement;
storing the targeted commercial advertisements separate from the program content at a first memory location, where each different targeted advertisement is stored only once;
insert into the digital audio-video stream index points identifying positions within the digital audio-video stream at which the targeted commercial advertisements occur;
associate a unique Ad ID with each different commercial advertisement;
creating an index file associating each index point with the Ad ID of the targeted commercial advertisement occurring at the position identified by each index point; and
store the received digital audio-video stream including the program content and the index points in place of the targeted commercial advertisements at a second memory location.

14. The system of claim 13, wherein the processor is further configured to:
initiate a playback of the digital audio-video stream from the second memory location;
identify the index points during the playback;
read Ad IDs from the index file based on the index points;
retrieve the stored targeted commercial advertisements from the first memory location based on the read Ad IDs; and
play back the targeted commercial advertisement at positions within the digital audio-video stream identified by the index points.

15. The system of claim 13, wherein the processor is further configured to:
identify a first targeted commercial advertisement included in the digital audio-video stream;
determine whether the first targeted commercial advertisement is stored at the first memory location;
if it is determined that the first targeted commercial advertisement has not been stored:
store the first targeted commercial advertisement at the first memory location;
associate a first Ad ID with the first targeted commercial advertisement;
insert into the digital audio-video stream a first index point identifying a position within the digital audio-video stream at which the first targeted commercial advertisement occurs;
associate the first index point with the first Ad ID;
store the first index point and the first Ad ID in an index file; and
store the received first audio-video stream including the first index point in place of the first targeted commercial advertisement at a second memory location;
if it is determined that the first targeted commercial advertisement has previously been stored:
insert into the digital audio-video stream a first index point identifying a position within the digital audio-video stream at which the first targeted commercial advertisement occurs;
associate the first index point a first Ad ID previously associated with the first targeted advertisement;
store the first index point and the first Ad ID in an index file; and
store the received first audio-video stream including the first index point in place of the first targeted commercial advertisement at a second memory location.

16. The method of claim 15, wherein the processor is further configured to:
initiate a playback of the recorded digital audio-video stream from the second memory location;
identify the first index point during the playback;
read the first Ad ID from the index file based on the first index point;
retrieve the first targeted commercial advertisement from the first memory location based on the first Ad ID; and
play back the first targeted commercial advertisement at the position within the digital audio-video stream identified by the first index point.
